(19) United States
(12) Patent Application Publication
(10) Pub. No.: US 2009/0202062 A1
(43) Pub. Date: Aug. 13, 2009

(54) System and Method for Communication

(76) Inventor: Chazon Stein, Miami, FL (US)

Correspondence Address: ROBERT M. SCHWARTZ, P.A., P.O. BOX 221470, HOLLYWOOD, FL, 33022, US

(21) Appl. No.: 12/186,783

(22) Filed: Aug. 6, 2008

Related U.S. Application Data
(63) Continuation-in-part of application No. 12/175,820, filed on Jul. 18, 2008.
(60) Provisional application No. 61/028,031, filed on Feb. 12, 2008.

(51) Int. Cl. H04M 3/42

(52) U.S. Cl. 379/218.01

(57) ABSTRACT

The present invention is a system and method for providing a connection to an entity from a request made to a general database, the system having a central contact and a list or database of word sequences purchased by entities; wherein the list or database has an associated telephone number contact information or address information and telephone or mail connection is made based on word sequence purchased by a particular entity.

### INDEX TO RELATED APPLICATIONS

This application is a continuation-in-part of U.S. patent application Ser. No. 12/175,820 filed Jul. 18, 2008, which claims the benefit of U.S. Provisional Patent Application 61/028,031, filed Feb. 12, 2008, the disclosures of which are incorporated by reference in their entirety.

### BACKGROUND OF THE INVENTION

It is often difficult for people to reach their desired entity by telephone.

The present invention is a system and method that enables an entity to purchase a pre selected word sequence on a directory and be connected when a request for connection is made based on the word sequence.

### BRIEF SUMMARY OF THE INVENTION

The present invention provides both a system and a method for connection to an entity based on the entity purchase of a word sequence.

As used herein, “entity” may refer to any person or business.

As used herein “word sequence” refers to words purchased by an entity that will be used to identify the purchasing entity and facilitate communication by a requester.

“Requestor” refers to a person who calls the central access number.

“Central Access number” refers to a number accessed by a telephone that connects the requester to a location that has access to a list or database that associates purchased word sequences with purchasing entities.

In one embodiment, the entity being a business that purchases a pre selected word sequence being a specific business category. The purchasing entity associates contact information with the specific word sequence.

When a requester calls a central access telephone number, the user requests to be connected with a business based on the business category. For example, if the user calls the central access number and requests “Chinese Food,” the caller will be connected to the business that has purchased the “Chinese Food” category.

In another embodiment, an individual may be the purchasing entity.

Any entity may associate numerous variations of the word sequence in order to receive calls from persons who incorrectly request the word sequence. The word sequences may be, but would not be limited to the individual's name, nickname, residence, profession and the like. If the entity is a business, the word sequences may include any combination of names, variant spellings, common products, categories and combinations thereof.

Thus, a purchasing entity may purchase multiple word sequences and associate each of the word sequences to the same contact information.

This becomes advantageous because entities are constantly trying to get others to remember their contact information. Utilizing the system and method of the present invention, a user merely needs to memorize a central access telephone number. That telephone number may be as simple as dialing “333.”

The entity does not need to stress in its advertising that a user remember an entire telephone number. The entity need only make sure persons know to dial a central access telephone number and request the appropriate word sequence.

The central axis telephone number will have access to a list and/or database associating various purchased word sequences with each of the purchasing entities.

The present may encompass Domain names for telephone numbers. If a person were to contact a central database and state a domain name (e.g. by computer, over the phone, or by mail) and ask for the associated contact information to that domain, the system will be able to be retrieve the information without having to ask the question “what city and what state?” (location around the world). This is because there is only one possible answer and that answer would be found by looking in the name line identifier directory.” (analogous to a domain name server). This contact information may be any or all of telephone, physical addresses, emails, and the like.

In one embodiment, the present invention is a system for providing a connection to a particular entity from a request made to the system, the system providing:

(a) a central access telephone number;

(b) a database of word sequences purchased by entities;

wherein the database directly facilitates a connection between an existing URL, URI, URN or registered internet domain names purchased as word sequences by said entities with entity presenting a query.

The system connects a entity making a query of the system directly to a desired registered entity without the need for a querrier (the entity asking to be connected) to provide a contact telephone number.

The system has an associated contact telephone number for registered entities that may be changed at any time by the registered entity that has purchased said word sequence.

The system has associated contact telephone number that is not revealed to persons accessing said system and requesting connection to an entity associated with a particular word sequence.

The system directly facilitates a connection between a pre-selected sequential word sequence that are not associated with a geographical location and that are not existing URL, URI, URN and registered internet domain names with a telephone number, or a physical address, with an entity making a query of said system.

The system informs an entity of the ability to contact another entity on a telephone by stating a URL, URI, URN and registered internet domain names, said system providing notification by a pre-selected sequential word sequence that are not associated with a geographical location and that are not URL, URI, URN and registered Internet domain names.

The system provides for an entity access using use a conventional telephone that is not Internet or web enabled, that would allow the entity to perform a search similar to an internet search engine (web enabled device) without any human interaction, that would result in the querying entity being directly connected on a phone with the entity that fits that specific search result.

### DETAILED DESCRIPTION OF THE PREFERRED EMBODIMENTS

In a preferred embodiment, a requester picks up a phone, dials “333” and says any word sequence or subject matter they wish to be connected. No more numbers codes will ever have to be remembered or stored.

It is similar to “411”, but you don't get a number to call or pay a fee. The central access number has a list and/or database of purchased word sequences and contact information for each purchasing entity.

The system and method is similar to World Wide Web searches, except a requester does not need to have a computer or use a computer to narrow a search.

Past attempts to make numbers more rememberable have included:
1-800-411-PAIN
1-800-CALL-ATT

Using the system and method of the present invention, a requester simply dials 333 and asks for:
“pain”; or
“ATT”

This is advantageous because some people can't see the “1/ABC” letter on the number keys to dial a call.

People recall names and phrases better than numbers.

### EXAMPLE

Operator at the central access number line simply finds your verbal word sequence request and transfers your call.

If the caller only remembers a partial name operator can suggest partial names or closer comparisons like:

Caller: “David Batterman Patten Info”

Operator: “Did you mean David Barman patent info?”

Caller: “Yes”

Operator: “Thank you, I'll transfer you.”

The system is further advantageous because T.V., radio and billboard advertisements all require you to recall a 7 to 10 digit phone number to connect to them. This is difficult because:
It's hard to find a pen in time
Hard to find the number you wrote down
Hard to remember numbers if no pen is available
They say number to fast and you miss it

The present invention provides a solution to having consumers easily remember and access contact with the business.

Additionally, an entity may incorporate the system and method of the present invention into all advertisements. At the end of an advertisement, when giving prospective clients the contact info say, for example, “Just call the name line “333” and ask for “hair loss for men”.

It is further contemplated the system and method may be used in the Internet.

Internet Site Overview
Name-Line “333”
Enter the name you would like to be recognized as:

| | | |
|---|---|---|
| 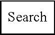 | Available □ Or Not Available □ | 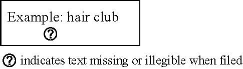 |

Enter the sequential number code you would like your name line
to be forwarded to:

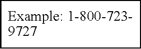

Credit Card Info:

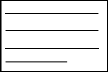

Optional

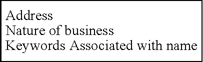

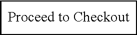

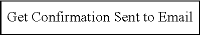

### Example 1

Caller: Dials “333”

Operator: Thank you for calling name-line, who would you like to be connected to?

Caller: “Hair loss for men”

Operator: “Thank you” (transfers your call)
No number is given to the caller
No charge to caller
No making a 2^{nd} call by the caller after receiving the number code (the caller only makes one call)
The subscribing company pays name-line for the “domain name” and a per-call forward

(a) Operator could be live or “voice over I.P.” service

(b) Caller could also text message in

### Example 2

Caller: Text “333” with subject matter “hair-loss for men
(our system would call him back)
(he would pick up the phone)

Operator: “Please hold, your call is being connected to hair loss for men”

### Example 3

Advertisement

411: To get a phone number

911: To get the police

0: To get the operator

333: To get name line

Examples of a “name line” (“word sequences”)

(a) Flowers
amazon.com
hair loss for men
David Barman patent info
Local fair
Dan the Man (nicknames/screen names)

(a) Example:

Flowers would be connected to 1-800-flowers

Name line (a verbal name spoken) will give you the contra-party intended with no sequential number recall ever.

1. NLI is the “Name Line Identifier” which is an embodiment of the system of the present invention. It allows people to use meaningful names such as “yahoo” to find phone -based resources (yahoo's phone number).

2. NLI works behind the scenes to remove much of the manual interaction of the phone and the ease of use is greatly improved.

3. NLI eliminates the need to manually remember phone numbers and replaced that system with human readable names instead.

4. NLI allows a name (identifier) to be linked to a phone number. Rather than having to remember a number to a phone you need to know just say the name of the party that you want to contact.

5. NLI is user friendly navigation. You can get to a party by entering a phone number into a phone, but remembering lots of arbitrary numbers isn't easy for most folks. It is much easier to remember a NLI identifier to a party that reflects its content, such as “hair loss for men”. (Hair Loss for Men being the name line and the company being a hair restoration clinic)

6. The internet uses domain names to link to an IP address. (this link is made through a DNS server) NLI identifiers are used as links to phone numbers. (these links are made through the NLID)

7. NLI records and configuration information is either stored in the master system registry, active directory, or global catalog. One index only.

8. NLI in its basic form simply is a database that matches names to phone numbers. (e.g. A company such as Proactive Skin Care, Inc., with the name line identifier “proactive” will be mapped to a particular phone number just like www.yahoo.com is mapped to go to a particular IP address. (through the DNS server)

9. A NLID links a user friendly name (such as Microsoft) to a phone number that Microsoft would like to receive calls at.

10. The ability to dynamically map host names (URL's) to IP addresses is particularly useful.

11. Names and phone numbers are distinct. This can lead us easily to imagine that they are two different kinds of objects. (e.g. Name=identifier which once attached to an object follows it for its life where ever it should reside. Phone numbers (set of codes) which change frequently whenever an entity moves out of that area code or changes from one location to another, or he could change jobs.

12. The NLI is not bound to any number code and can be rerouted anytime so you can keep your contact NLI (contact information) for life. Whereas, with the phone number there is a threat to its longevity.

13. It is simply a matter of choice between contacting an entity using a NLI or a phone code, of which a NLI follows you throughout life and a phone number can change from time to time. (e.g. When your phone number changes, you must contact all incoming callers to notify about the change of phone number. People that you cannot find to tell about the number change will not be able to find you years later).

14. If a locksmith with the NLI “Help Locked Out” wants to retire he can sell the NLI to someone else so that the veteran clients who call will be forwarded to the new company. Building up a good NLI in a business can give your NLI a “good will” value that you can sell for money.

15. Phone numbers decrease contact longevity. NLI keeps contact info the same for life.

16. This discusses the introduction of URI (uniform resource identifier) or URL (uniform resource locator), domain names and any kind of name combination identifier that is denoted by a special record, as an identifier in a system that is used to locate a phone number.

17. One can with ease make the reference to something (advertisement) or someone (friend or business) to the master NLID and be forwarded to that persons phone code, assuming that person is up to date on the fees and has registered properly.

18. NLI is introduced because repeating and remembering the code to a phone is much too cumbersome.

19. NLI will usually be something equivalent to the companies' dynamic and all the person has to do is refer to the concept to find the intended contra party, whereas with number codes that would never be possible.

20. Directory for phone numbers. Companies like “411” and “0” for operator or online directories like “anywho.com” To find an entity you must be able to give city, state and listing and sometimes even more descriptive information is needed. “address” If you do not know the location most of the time you cannot get the phone number. If you get lucky and the company is one of a kind (unique) or you can recall the address, the directory gives you the phone number or will text message you the number or will do both as well as directly connect you to the contra party.

21. The key factor is that you get a phone number out of identifying the business name and demographic location.

22. The NLI is not necessarily the business name and there is only one location. That location is the NLID.

23. Every NLI has the same location so a NLI owner can physically move to the moon or any place in the world that is able to receive phone calls and his NLI location is simply the NLID.

24. Abstract=NLI are not found through stating the location of the person/business. This would never be a requirement (it can help if you cannot recall the exact NLI, by using key search words).

For example a person says the wrong NLI to the NLID system.

Ex:

Caller calls NLID and says NLI “Club Mace”, and then NLID says, “no match”.

Case 1: NLID—did you mean Club Space?
Caller—Yes.
NLID—will forward your call.

Case 2 NLID will ask you for key words. (relevant to that NLI)
Caller—Dance club/drinks/Madonna Concert/Miami Beach/Florida
NLID—will match all keywords and along with the attempted recall Club Mace to find Club Space.
NLID—Did you mean club space?
Caller—Yes
NLID—Thank you. Forwarding your call.

25. Comparing the computers internet to phone directories, if you went to an internet directory and asked for an address to a website.

Ex:

www.yahoo.com the internet directory would say http://www.775.891-18.88.com/info/homepage Then, you would have to store this internet address to recall the location later, and if you were not put directly through, you would have to type in the address all over again.

Problems
Type address code in wrong
Can't recall the code at a later time
Too time consuming and cumbersome.

To make this process simpler you put in a URL and it goes right to an IP address. You never see the IP address. This is done through a DNS system.

The same process but with phone directories would be

Same example but with a different process except this process has not yet been improved.

Caller attempts to call phone directory.

Phone directory says, “what city, state, listing?”

Caller gives appropriate information

Directory gives caller phone number. (305-555-1212)

Caller options=Hang up and dial phone number (he made two calls in total. One call to directory is made, then he makes another call to the contra party

This is the same problem with the original computer internet directory example; however, this was corrected by using the DNS server to connect URL's to IP addresses.

Phone directories were not improved until now with the NLID

26. URI/URL/Domain name=the prefix (HTTP/www.) and the suffixes (.com, .net) are all different descriptive components that make each address unique. This allows you to be pointed to a distinctive web page or server location. (IP address) This is all stored in the DNS server.

27. With NLID any pre-selected word combination makes up a complete unique identifier. (URL)

Example of a NLI Could Be:

Dan the man (a person's nick name)

The ticket clinic (Law firm for traffic tickets)

When you say one of these NLI's to the NLID you will be linked to the forwarding phone number. The number will never be revealed to anyone. After the connection is made the contra party is free to reveal his own personal number to the contacting party if he wishes to be called by that person again at a later date. Then, the person could bypass the NLID system.

28. Phone numbers will change over time ceasing all contact threw that channel. NLI can be held indefinitely. Only the phone number that you preselect your NLI to be forwarded to would change.

Ex:

Daniel Silvermith has a NLI “Dan the man”. He lives in a 305 (Florida) area code and now moves to a 917 (California) area code. He only would have to update his NLI account with a new forwarding phone number. This does not change the way people contact him. This process allows people to use the same NLI, “Dan the Man” to contact Daniel Silversmith. Daniel Silversmith will not loose touch with his old contacts.

Ex:

Independent contractor works for a brokerage firm with phone number 1-800-prudential. If he moved to Smith Barney (a new firm) his old clients would not know how to get him on the phone.

Reasons Why:

1) He could not get past incoming callers on the phone to inform them of his job change.

2) The old firm does not know the location or the phone number to the independent contractor's new job.

If the independent contractor had a NLI such as “Buy Bonds from the best” the client as well as the independent contractor would not be bothered with the change. The past incoming callers would know how to get him on the line. All the independent contractor did was change the settings on his NLI account so that his personal NLI would be forwarded to a new phone number. Even though the independent contractor's location changed along with his phone number, the location of his NLI (Buy Bonds from the Best) stayed the same.

Ex:

If the change was just temporary as he moved around the world he would be able to be contacted in any place just by changing the setting on his NLI so that the NLI would be forwarding to the number of the new location.
1) The hotel he is staying at. People call and ask for him by name and front desk would forward to a hotel room. (NLI goes to hotel phone number)
2) A holiday weekend trip to your in-laws house in the mountains. That person's cell phone gets bad reception but a home land line will work will. (NLI goes to the in-laws phone number)

NLI follow you for life like your social security number.

Phone numbers will change especially when you move out of your area code, state, or country numerously throughout your personal and professional business life.

29. If a person recalls a NLI incorrectly the operator will get on the phone for assistance and will type into the NLID system your attempted NLI recall. The NLI will give you similar options to pick from. A list of key words, hint and facts pertaining to the NLI can be included to help the NLID system identify a NLI. (The NLI owner has the option to add these linked facts to his specific NLI)

Ex:

NLI=Rand Eye Institute

Optional=key factor=added by the NLI owner would be: Eye doctor, surgery, office location, city, state, vision care, radio/TV add, nature of company, slogans, HMO, PPO. (No insurance accepted)

By caller saying these key words along with a close NLI, the computer would be able to match up all the components to find the correct NLI, and then will be able to forward the call.

Ex:

Caller calls NLID and asks for the wrong NLI

Caller says, “Randy Institute”

NLID says no match

NLID would ask for key words associated with the party you wish to call.

Caller=says I heard an add on the radio for an eye doctor

NLID=takes words like radio add, eye doctor and the incorrect

NLI randy institute to get:
Rand from Randy
Eye from eye
Institute from institute
Radio add=This is also a key word
NLID computes Rand Eye Institute
NLID—says did you mean Rand Eye Institute
Caller—Yes
NLID—Thank you and transfers the call.

The NLID has different classes in its directory such as; radio ads, TV commercials, doctors, lawyers, financial institutions, nick names, sir names. These classes are almost like the top level domain names for the internet. (.edu .gov. net)

30. Big corporations with NLI can have sub name line identifiers.

Hierarchal System

Ex:

Walgreens is the top level NLI (top of the pyramid) The company can either have the top level NLI go to its corporate office and from there assist the caller to find the correct location narrowing down his search. Or the company can have a pyramid set up with the NLI directory.

Ex:

Caller would call the NLID and say the NLI “Walgreens 103^{rd} street in Miami”. (This is a sub NLI).

Example of a top level NLI with sub NLI and with sub NLI's with strings attach to them.

Top level=“Walgreens”

Sub NLI=“Walgreens Miami 103”

Sub NLI with strings attached=“Walgreens, Miami, 103, Pharmacy”.

Note: These can be said in any order. NLID can also take out words with no meaning such as at, in, and on.

Ex:

Caller calls NLID and says “Pharmacy at Walgreens in Miami on 103^{rd}”

NLID narrows this to “Pharmacy Wallgreens Miami 103” (the correct NLI) and then would proceed to forward the call.

31. This system is also a referral service similar to search engines.

Entity can only register a NLI that has both a subject and description.

Ex:

An entity would not be able to register the NLI “doctor”. An entity would be able to register the NLI “Dr. Michael Krop”.

Doctor=being the subject

Michael Crop=being the descriptive part

If a caller calls the NLID and only says “doctor”

NLID will send him to a live operator service

NLID operator asks what, when, where, and why type of questions NLID will enter in the doctor zone and puts in all of these key words

NLID will then pick the best option for the caller and forward him to the selected NLI subscriber.

Ex:

An entity calls NLID and says “doctor”.

NLID—hello, what kind of doctor?

NLID—where do you live?

NLID—Do you have health insurance?

NLID—Is it an emergency?

Caller—child needs check up, I live in Miami, Fla., and have health insurance.

NLID uses these key words

NLID will then come up with a few options all with equal amenities. The only difference is the one who is willing to pay the most for the referral will get the call forwarded to their NLI.

NLID will keep a record of NLI referral forwarding and will bill the NLI owner appropriately. (assuming the NLI owner elected for this option)

There are three types of NLI forwarding.
1) A NLI is stated correctly and then is forwarded to a phone number.
2) NLID helps the caller find the correct NLI using key words and then uses the correct NLI to forward the caller to the NLI forwarding phone number.
3) The NLID operator refers the caller to the NLI owner that is matched with the caller's needs.

These are just different things the NLID can do. The main invention here is that NLI's are used to identify and forward callers to phone numbers with the NLI having one central location, that being the NLID. (This is similar to the way the DNS server is used to connect URL's to IP addresses on the internet).

32. All government and educational numbers will be registered and maintained free of charge.

Ex:

911, FBI, missing persons, Baptist Community Church

33. Phone numbers are saved in a phone under a name. NLI can be saved under a name in a text line format.

Ex:

Daniel Silverstein—305-984-3038

Daniel Silverstein—333—“Dan The Man” (333 being the number you are texting and Dan the Man being the subject.

This will be in the text message format. You text the NLI and it will call you. When you pick up it will then automatically forward your call.

34. NLI with similar spelled and sounding words will all be incorporated into one NLI

Ex:

NLI—to the sea
2 the see
Two the see
Too the see

Two different entities could not get similar spelling or sounding NLI's unless one or more descriptive identifiers were appended to the entire NLI.

Ex:
To the beach
2 the zoo
Or
Eat on the water
Sports on the water

Each subject and descriptive wording must be unique in its combined components.

35. You will never have to change your contact information again.

36. A phone number is a threat to personal contact information longevity. Phone numbers change with jobs, but your name line will always be with you.

37. NLID allows one NLI to point to more than one phone number.
1) first number rings five times with no answer. Then, call will be forwarded to a second number. We can also provide voicemail.
2) You can use two different phone numbers so that one can be used at one time of the day and the other for other times.

38. You do not even have to have a phone number to use this service. You can put your NLI forwarding option directly to a voicemail so it never rings a phone number at all. NLID just forwards it to your account's voice mailbox. This would be good for product information lines. In the company's message they could direct you to different places to call if you needed more information.

Another option is setting NLI up to say this is a correct NLI however at the present time the line is on hold or we are on vacation and will be back soon.

39. DNS (Domain Name System) is a system that matches and forwards URL's to IP addresses.

Yahoo.com and yahoo.net are different identifiers even though part of the domain identifier is the same. This just tells the DNS to send each one to a different IP address.

With regard to the NLID no one could ever come and say that by adding some code or wording to a NLI or by making some new phone number to call and access a different NLI concept, that this would be a new concept and different system.

40. Any system no matter how it would be accessed machine or personal that has any kind of directory that uses NLI (sequential word identifiers) by itself (without a location needed to find the listing to facilitate a connection to a phone number) would be an infringement on this process.

Ex:

A caller would call the phone directory and say, “Club space Miami, Fla.”

The phone directory could use this information to forward the call.

The key here is that you gave a registered business name with the location so the directory could locate the number and at your request forward your call

NLID could have the same information with the NLI being “Club Space, Miami, Fla.”. Club Space might also be a registered NLI, but for this example club space only has one NLI. Club Space is registered with two different directories.

1) With the NLID (NLID has the NLI “Club Space Miami Fla.” registered in the system.)

2) With a business directory it is registered as:

Club Space

40307 wax drive

Miami, Fla. 33131

305-877-8598

The directory uses the name and location of the entity to find the information on club space's phone number.

Ex:

The NLID uses the NLI “Club Space, Miami, Fla.” to find and forward the phone number.

This is the NLI and the NLID found it without a location. There is only one NLI like this of its kind in the NLID system.

42. The key here is phone directories are able to look up a business or personal name in the phonebook sometimes using general and other times more narrow instructions if known by the caller. (such as city, state, street, crossroads)

Ex:

Phone directory gets a query like club space. Phone directory would then ask Florida or New York. Caller would say Florida. Phone directory would then give phone number and if you would like them to forward the call for you.

NLI can and will sometimes be duplicated with phone directory searches.

Ex:

Phone/Internet directory—Club Space, Miami, Fla.

NLID—NLI—“Club Space Miami Fla.”

Phone directory uses key word searches such as “Club Space” to narrow down the listing if there is more than one club space. It then uses location to narrow the search. It can also ask if club space is a golf club or a nightclub.

Phone directories do not really have descriptive key words to help find the party. NLID has the option to add in the key word box different wording pertinent to the entities NLI that will help you find the match. (This will help the NLID find your NLI in a search)

43. Phone directory would never be able to find a phone number to a query such as:

NLI—club space girl

NLI—club space rsvp line mike

NLI—Mike club space promoter

NLI—Club Space available—keywords real estate broker

NLI—Buy tickets Club Space Madonna

All the preceding NLI are free from attachment to a company commercial identifier or any kind of chapter S or LLC or some things you could find if you looked on sunbiz.org. These NLI are not attached to a physical location. One could not use a directory to find these NLI because they are not grounded to a specific city, state, country, or continent. There is no physical location to NLI's except the NLID

Therefore, any help, search, phone directory system would not be able to assist forwarding numbers or even finding the number you ask for if the caller or person on the computer looking for the number used an NLI that had no location attached to it and if the NLI was not part of the entities name.

Ex:

NLI—“Club Space, Miami, Fla.” has both company identifiers and location attached to it so this would be an overlapping exception, and there would be no infringement done.

Phone directories could give the caller the same number that the NLI directory uses to forward the call to. This would be fine. The infringement comes in when it has to do with how the phone directory gets the number you want.

Phone directory—American Airlines would be forwarded to 1-800-America

NLID—Fly High would also be forwarded to 1-800-American

Both go to the same phone number at the end. The difference is how the information was retrieved.

Ex:

Phone directory—used a business name and location search to get the phone number.

NLID—Did no business name or location search. They just went to the NLID and found that NLI. and proceeded to forwarded it to the pre-selected phone number. The fact that the companies name is American Airlines had no effect on the search.

Phone directories could not use “fly high” as a record locator for forwarding calls, except if “fly high” was a registered company with an address in the phone book there would be no problem.

NLID goes to database and only finds one item and then forwards the call.

Proactive is for this example the registered name of a company that has a location (address) associated with it.

If a directory would be called and asked to find the number for Proactive, the directory could use the uniqueness of companies name along with a location on the map to find and give it the number.

Now, if Proactive had a new product under their trade name (Proactive) called “new soft cream”. New soft cream is a product not a business location.

Proactive could register “New soft cream” as a NLI. Then the NLID would forward all calls for the NLI “new soft cream” to a pre-selected phone number.

If a phone directory was asked the number to be forwarded to “new soft cream” they would not be allowed to access the NLID to fulfill the caller's request. Unless “new soft cream” was registered as a business name with a location on the map with a phone number attached to it.

The key is the NLI does not have a location attached to it. They are all held in one central location and are never held exclusively to one phone number.

Jack Black is a registered NLI. It is not a business and has no location. It belongs to a man named Jacob Blackwell. He has had the NLI for 50 years. His high school friends remember his nickname and still to this day he gets called from all his old friends. He has changed phone numbers 17 times and lived out of state as well as other countries. But, people can always get in touch with him just by calling the NLID and saying Jack Black.

The key here is that every time Jacob Blackwell is relocated or given a new number, he just updates his NLI by entering the NLID and changing the phone number that the NLI Jack Black uses when it forwards calls.

NOTE: This is similar to the way a domain name can change the IP address that it is forwarded to. (This is done by updating the DNS server)

Domain names never change. Only the IP address changes. NLI never change. Only the phone number that the NLI uses to forward calls to.

If the NLI forwarding phone number is connected to a long distance number the caller will be prompted before the call is put through.

Ex:

Caller—Jack Black

NLID—This NLI at the moment is being routed to an overseas call in Europe with area code 303. Please check with your carrier to find out what fees you will be charged. If you hang up now there will be no charge or stay on the line and the call will be connected.

NLID can connect to over seas phone numbers as long distance phone number without prompting the caller if the NLI owner will pay the charge for them.

Ex: 1-800 number caller pays nothing and receiver pays charges.

You could use a 1-800 number as the number you wish your NLI to be forwarded to.

To register for a NLI you can go online, mail in a form, or call on the phone.

We do not publish a NLID book. It is the NLI owner's responsibility to get his name out there. We only acknowledge that the NLI a person would like to get is not available.

You can access the NLI directory online and search for somebody. There are two boxes:
1) NLI
2) Relevant Key Words

The key word DNA will then come up with suggestions.

Ex:

If the NLI is put incorrectly the NLID will say “Did you mean?”______ and give suggestions as well.

NLID will not give you a phone number. You must then use a phone line to get the party. The online NLID only helps you identify the NLI.

NLID:
Never gives out your number
Keeps your NLI for life/indefinitely
No location needed to get NLI information/forwarding.
Can change numbers and location unnoticeably.

The World Wide Web is a vast network of information within the internet.

The NLID is also a vast network of information that is used to connect people to each other.

The web and internet is divided into zones, which organize pages according to the type of information generally contained within them. There is of course some overlap but generally the zones are:

.edu—Education

.net—For internet related Institutions

.gov—Government

.com—Commercial entities.

The ICANN (Internet Corporation for Assigned Names and Numbers) is the official governing body for domain names. (DNS does the actual matching and forwarding.)

My invention has both ICANN and DNS components. We assign the names; store the names and our service forwards the calls.

The internet was created by the US Department of Defense in 1969 as a faster way for agencies to share information as an emergency means of communication in case more traditional means were cut off. In my opinion, the U.S. Department of Defense is subsidized by the U.S. government. The invention of the internet belongs to the United States Government because one of its entities came up with it.

ICANN is a government official body that is in charge of domain name registration.

A government official body is in charge of this because the government made this new process (the internet) . . . I think so.

So to, the NLID is a new process that allows people to keep their personal ID contact information for life or indefinitely. All the person has to do from time to time is change the number that the registered NLI is being forwarded to. The location of a person is never an issue. It is always in the same place (NLID).

This new process did not come from a government subsidized product. It was invented by a single entity. Therefore, it is a patented process that will allow the exclusivity of a single NLID network meaning there can only be one entity in charge of giving out domain names for telephone numbers as well as keeping a master index and facilitating the call forwarding.

ICANN keeps logs and keeps control over internet IP addresses as well as domain names/URL's.

NLID keeps logs and control of NLI as well as facilitating the service of forwarding NLI to phone numbers.

Today, the internet is the world's largest communication network. The number of names registered in the domain name system that goes with web sites (IP addresses) for commercial enterprises, public institutions, and private individuals have exceeded tens of millions.

The networks and switches that make up the internet carry data around the world in a second and link even the most remote user to a vast wealth of information. The most popular network on the internet is the World Wide Web created in 1989 by CERN, the European particle physics lab in Geneva and made available on the internet in August, 1991. Here they speak of the domain name systems for web sites (IP addresses).

The invention of NLID is a domain name system used to issue NLI's, store NLI's as well as identify NLI that will forward calls to a phone number. This is similar to the DNS system that connects URL's to IP addresses for internet use.

With NLID this is the only index that will issue and hold information that has to do with domain names that will be linked (used as a pointer) to a phone number.

There can be no other network indexes involved in this system.

Ex:

A URL gets forwarded to an IP address. A URL would be the domain name and the IP address being the web page.

With the NLID any prefix or suffix added to a NLI would just introduce a new NLI with its own forwarding number.

Ex: 333 NLID has a registered NLI “Billy the Kid”. A company cannot say they are 444 directory and they have their own system that forwards domain name identifiers to phone numbers and they would also register the domain name identifier “Billy the Kid” to be forwarded to the same or different number.

Ex:

333—Billy the Kid

444—Billy the Kid

This 444 access line that uses domain names to identify phone numbers as well as forward calls would be an infringement on the NLID intellectual property.

444 could be a directory but “Billy the Kid” would have to be a business that is registered in a directory that has a location attached to it.

“Billy the Kid” could not have one central location. That being the 444. If 444 was using that domain name style to forward phone calls that would be an infringement.

The NLID when used in radio and commercial adds is a highly convenient purchasing vehicle for the end user.

NLID has an array of services from call forwarding to help identifying the correct NLI by offering close suggestions as well as a referral service based on the NLI owner's key facts. This is the information that is held behind their personal NLI (doctor, insurance, companies).

With so many phone numbers being related to us on the radio and television advertisements as well as quick encounters with friends, it is almost impossible to recall the code of a number at a later time.

With NLID it is easier for an interested party to recall your contact information with a slogan or a couple of words, than it is to recall seven to eleven numbers.

The internet remains the fastest growing and most versatile resource in media history. A key to this is the domain name systems. This system allows domains (URL) to be forwarded directly to the IP address on the internet. This helps people find other people and companies on the internet. They do not need to know the IP address. All they must recall is the domain name to get to the website they wanted or to send mail to a person on the internet.

With NLID the person does not need to know the location or the phone number. Only the NLI is needed to get the person on the phone.

Radio and TV commercials repeat an eleven digit phone number three times fast at the end of an advertisement so you can try to recall it moments later when the ad is over. The person most of the time is able to recall the product he wanted to by, but not the phone number to get them on the phone.

With the NLI used at the end of an ad to give the potential customer the contact information, the recall is almost effortless.

Ex:

An infomercial on television advertises a gym product called “AbFlex”.

The consumer wishes to buy this product a couple of days later except he has trouble recalling the phone number but no problem remembering the product name he wanted to buy which was “AbFlex”.

The person can just call the NLID and say “AbFlex”, and the call would be put through to that company. In this way there is no need to recall the phone number.

If the person could not recall both name and number and he said “Ablex” (an incorrect NLI) the NLID would ask for keywords. The person would say, “it is a workout product I saw advertised on television”. The NLID would be able to combine the keywords “Ablex” workout product and TV advertisement to find the correct listing. The NLID would then say, “Did you mean AbFlex?”. The person would confirm this and the call would then be forwarded.

The new embodiment increases the efficiencies of radio and television advertising by enabling the contact information to be recalled easier in a person's long term memory.

The address is the location of an internet host. An e-mail address might take the form of Johndoe@xyz.com. A web address might look like www.xyz.com. Both are examples of URL. (URL's are similar to NLI's in that they both make up unique identifiers.)

A URL (uniform resource locator) is the address that identifies a web page to a browser also known as a web page.

A browser is a program that translates the hyper text markup language of the World Wide Web into a language ordinary that people can understand.

A URL identifies and connects to a web page. This process is done through a DNS server.

A NLID identifies the NLI and then connects it to a phone number to facilitate a phone call.

A bookmark is a browser feature called favorites in internet explorer. This stores a list of pointers (domain names) to website for easy access at a later time.

NLID is like a big bookmark that stores a pointer (NLI) to a phone number for easy access later.

Intranet is a network of computers accessible only by members of the network, often members of one firm, also known as an internal network.

The NLID is like an intranet since only NLI owners can access their own account, and no other network could use the NLID information to forward calls. A person making a call to the NLID only gets a service of forwarding a number. They do not get the actual phone number.

ISP (internet service provider) is a company that provides end-user access to the internet via its central computer and local access lines. There are many different ISP's.

NLID is also a service provider that provides end-user access. The difference is we connect NLI with access to a specific phone number on a phone line.

NLID has utility, novelty and is non-obvious. What NLID has done is taken the phone number out of the equation when it comes to identifying a person or business you would like to be connected to on the phone.

How?

By replacing the old contact information (phone number codes) with a domain name identifier system. This system uses the unique domain name as an identifier to the existing phone number. When a person calls the NLID and asks for a specific NLI, the NLID will go thru its index and pull that account up.

Then it will use the phone number in that account as a forwarding number to that specific NLI.

This process will allow a persons phone number to change but the persons contact information (NLI) will stay the same.

A server is the central computer in a network, providing a service or data access to a client's computer on that network. Frequently, a web server is dedicated to a specific function such as email.

A search engine is a tool used to look up web pages, also known as an index or directory.

The functional difference between internet domains (URL's) and telephone number domains (NLI's). The NLI goes to a phone number. The URL goes to an IP address.

Ex:

All phone domain name connection requests will be sent to the NLID for identification and call forwarding. With internet domain names, the same process occurs with all URL's going to the DNS to be matched and then forwarded to an IP address.

With NLID there is only one option for each individual NLI.

Search engines use software agents called “spiders” or “crawlers” to index contents of individual's web pages, and then follow links to other pages.

Web directories are compiled by humans who classify sites under topical headings.

Some search sites on the internet use both search engines and web directories.

A directory style search provides two ways to research.

1) For broad topics you can dive through a list of topics by clicking on the appropriate links.

2) You can fill out a search box to find a listing.

A search engine style search is for more specific information. Because, they use an index of key words drawn by “spiders” from millions of web pages.

In both examples each search result comes back with a considerable amount of options.

NLID Style Search:

Each subject matter assuming it was recalled correctly, will only come up with one option which is that registered NLI.

Ex:

NLI—Proactive

A computer or phone directory will ask you for a location. A search engine will pull up everything with the word “Proactive” in it.

A web directory will need to know what kind of product it is, or service they provide as well as the location.

NLID will only pull up one option. It does not do a search. It only goes to the NLID.

NLID can do a search but this is not the patented idea of the domain names for a phone number.

Searches come back with fistfuls of information. NLID will only come back with one option. (Phone number)

Most search sites deliver too much information. Search engines do a good job on indexing but because of that they deliver more information than you need.

No two search sites index exactly the same set of web pages.

NLID is different in that it is not a search engine or a phone book directory used to find phone numbers based on people's locations.

NLID is a single index made up of pre set unique domain names used as a way for a person to contact another person without having to use a phone number. All the person does is identify to the NLID the specific NLI you would like to get on the other end of the phone. The NLID then takes that NLI and then pulls up that specific account in the master index and uses the phone number in that account as a forwarding number. (This is similar to the DNS server that matches URL's to forwarding IP addresses.)

Exploring websites yourself you find web pages you like and add them to your bookmarks or favorite list on your browser.

This is considered to be a personal index. The person knows that at a later date he can go to bookmarks, or favorites, and by clicking the domain (URL) he will be forwarded to the web page (IP address).

NLID is a similar index whereby a person at anytime can call the NLID and just say the NLI and he will be forwarded to the contra party.

Communication connectivity is one of the key functions of the NLID in that it supports human communication.

The internet is a dynamic collection of computer networks that interact with each other.

NLID does not allow other networks to access our information. It is a single, independent, exclusive index used for registering and storing NLI's as well as facilitating the forwarding of NLI's to phone numbers. The service will identify or help you identify the correct NLI by using key words. This NLID can also be used as a referral service.

The internet engineering task force publishes its IP address standards and has increased the number of available addresses allowing almost every electronic device imaginable to be assigned a unique address.

This is just like phone companies that issue phone numbers to people with different area and country codes.

NLID has nothing to do with the issuing of telephone phone numbers. The NLID simply stores phone numbers in the system to be used as forwarding numbers.

NLI are used to identify that particular phone number.

Similar to URL's that are forward to IP addresses.

Ex:

Using the internet—www.yahoo.com would be forwarded to an IP address 7221.888.222.4/html

Using the telephone NLID—Dial 333—say the NLI “Yahoo” and then you are forwarded to 305-555-1212.

Phone Address

The fundamental part of an address on the NLID is called the domain, which is made up of any kind of unique name sequence. Prefixes like “www” and suffixes like “.com” simply make up a new NLI. The front, middle, and end of a NLI is uniquely worded to make up a single registered identifier to be stored in the directory.

NLI are used to identify phone numbers that have already been assigned to the NLI owner by a phone company. That number will be used by the NLID to forward the calling party to that particular phone number.

URL's go to IP addresses and you do not see the IP address.

NLI's go to phone numbers and you do not see the phone number.

In 1998, under a contract with the U.S. Department of Commerce the non-profit Corporation for Assigned Numbers and Names (ICANN) was established to oversee the management of such basic internet functions as assignment of domain names and internet addresses.

The internet is a vast and rapidly growing computer network.

The NLID is not a network of networks, or a search engine that uses web crawlers or spiders to find information and it is not a directory to find businesses/residences based on their location.

The NLID is one single large database that uses domain like names, URI's, or URL's or any unique combination of words that are registered for the sole purpose as to be used as a unique identifier when a person would like to contact another person on the phone without dialing a phone number or having to remember a phone number, or know the location of the person when calling a directory. All the person has to do is call the NLID and say the unique NLI and the call will be put thru.

Just as the ICANN has the sole function of assigning domain names that are used to be forwarded to an IP address. (web pages on a computer)

The NLID has the sole function of assignment of domain names, storage of domain names, as well as forwarding NLI's to phone numbers (people to talk to on the other end of the phone line)

Internet Addresses

The fundamental part of an address on the internet is called the domain. The final part of the domain name, known as the top level domain (TLD) is the most basic part. The “.com” is the TLD.

So called generic TLD's are consisting of three or more letters.

Ex:

.com

.jobs

.net

Domain names with two letters are generally for countries or regions.

Ex:

.us (United States)

.eu (Europe Union)

.jp (Japan)

All of these components make up a complete URL/URI which is then forwarded to an IP address.

NLID would give first priority to companies that would like to get their commercial identifier, slogan, or their internet domain name (URL) as their contact information.

Ex:

1-800-Flowers would be able to have the first option on the NLI “1800FLOWERS”

NOTE:

A competitor to 1-800-Flowers would not be allowed to use the 1-800-Flower commercial identifier as their NLI contact information for their own company.

Ex:

Burger King could not use the NLI McDonalds. But, they could use the NLI “The Best Burger”

The NLID would use solid judgment in giving out NLI to people.

1-800-BAR-CALL

(1-800-227-2255)

1-800-CAP-BALL

(1-800-227-2255)

Both of these numbers dialed thru the 1-800 number systems would go to the same place.

1-800-BAR-CALL and 1-800-CAP-BALL could not each be their own unique contact information, because the different letters in both examples represent the same numbers. They just use a letter associated with a number formula on the telephone key pad dialer.

If one were to dial both 1-800-BAR-CALL and 1-800-CAP-BALL using the 1-800 system they would both be sent to the same place.

The problem here is that the 1-800 number systems could not have both 1-800-BAR-CALL and 1-800-CAP-BALL represent two different parties contact information.

The solution is the prefix 1-800 code of BAR CALL and CAP BALL (letter associated with numbers) would have to be changed.

Ex:

1-800-BAR-CALL

1-877-CAP BALL

By changing the prefix code these numbers will now represent two different parties.

With the NLID the prefix code is always the same.

Ex:

333

The NLID could have both BAR CALL and CAP BALL represent two different parties contact information, while still using the same prefix. This is something the 1-800 number systems could not do.

Ex:

333—BAR CALL—goes to sports bar.

333—CAP BALL—goes to baseball store.

1-800-BAR-CALL and 1-800-CAP-BALL would both go to the same place.

The NLI “BAR CALL” and “CAP BALL” are both unique identifiers. The fact that the letters correspond to the same numbers on the telephone keypad is not a material issue.

Examples of Possible Confusion:

A person hears a 1-800-411-PAIN commercial on the radio. Later, he is not sure if the 411-PAIN prefix was 1-800, 1-877, 1-866, 1-888, etc.

If this radio station used the NLI “411 PAIN” there would be no confusion as to what prefix was needed to be placed in front of the “411 PAIN”

The only option for the NLI “411 pain's” prefix would be the NLID 333.

The NLI “411 PAIN” is said in to the phone or text. The key here is that there is no process of matching letters to numbers on the phone's keypad to connect to the contra party.

NLI could also be used to forward mail. Just mail the letter to NLID which would go to our own post office box, and underneath simply put the NLI.

Ex:

PO Box 333

NLI—Dan the Man

We would have the NLI forwarding address on file. Mail would come to us and we would simply forward the mail.

On the computer you go to the address bar, type in the URL, and then it is sent to a DNS and the DNS matches that with an IP address and forwards the results to a web browser. The web browser then uses the received results and processes the information in order to reach a desired web location.

NLIAD (Name Line Identifier Address Directory)

A key feature to NLI for addresses is that you do not have to disclose your exact location to someone to sender to get mail from them.

When someone uses a post office box to receive mail they are still disclosing the vicinity of the location which they reside at to the sender.

Ex:

Post Office Box 75528

Miami, Fla. 33187

The problem is that you are still disclosing the city and state where you reside in.

With NLIAD your senders will never know where your mail is going to.

Unwanted visitors to your residence would never be an issue.

Ex:

A person in protective custody has an NLI “Fat Rat”.

Sender puts mail with the address of:

Post office box 333

NLI—FAT RAT

Sender can send information to a person even though he does not know where he lives.

With NLIAD Billing the sender could go on-line or call the NLID and say “I would like to send mail to FAT RAT. I am located in the Unites States with the zip code 37285. NLID will respond and say that the mail will need a $0.50 postage.

Other Option:

No stamp is needed. The NLI owner receiving the mail would be billed by the NLID at a later time.

The matter of billing is not an issue in the intellectual property so it can be done in many different ways.

Domain

1. a portion of the Internet distinguished by a particular final part of the name. For instance, www. covingtoninnovations.com are two servers in the domain covingtoninnovations.com, which is a subdomain of .com(its TOP-LEVEL DOMAIN).

2. in Windows NT and its successors, a group of networked computers that share a server and a set of user accounts.

Domain address

1. an Internet address in conveniently readable form such as jones.com, as opposed to the IP ADDRESS, which consists of numbers.

Internet

1. a cooperative message-forwarding system linking computer networks all over the world. Users of the Internet can view information on the World Wide Web, exchange electronic mail, participate in electronic discussion forums (newsgroups), send files from any computer to any other via FTP, or HTTP, and even use each other's computers directly if they have appropriate passwords. Every user of every machine on the Internet has an IP Address. For example, the address

beetle.ai.uga.edu

means:

| | |
|---|---|
| beetle | machine (“beetle”) |
| ai | subnetwork (Artificial Intelligence Lab) |
| uga | site (University of Georgia) |
| edu | type of site (U.S. educational) |

Here beetle.ai.uga.edu is a domain address that gets translated into a numeric IP address, such as 128.192.12.9, by the network itself.

The cost of running the Internet is paid largely by the sites that receive messages, and the sites that pass them along, not by the sites that send messages out. This has important legal and ethical implications. Unsolicited advertising via email or in newsgroups is almost always unwelcome, as is any self-serving misuse of electronic communications, because the sender of the material is not paying for the cost of disturbing it.

UDDRP,UDRP (Uniform Domain Name Dispute Resolution Policy)’

1. a process established by ICANN to allow trademark holders to wrest control of domain names away from domain name poachers. An arbitration panel decides if the domain name holder obtained the domain name in bad faith to violate the trademark.

The system of the present invention also includes, a system that directly facilitates a connection between an existing URL, URI (Uniform Resource Identifier, the generic term for all types of names and addresses that refer to objects on the World Wide Web. A URL is one kind of URI), URN (Uniform Resource Names are an internet standard for unique identification and permanent addressing of digital objects) and registered internet domain names with a telephone number, or a physical mailing address.

Preferably, the invention encompasses a system that directly facilitates a connection between a pre-selected sequential word sequence that are not associated with a geographical location (city, state, ex) and that are not existing URL, URI, URN and registered internet domain names with a telephone number, and physical mailing address.

The system has the ability to promote in any form. That would inform an entity of the ability to contact another entity on a telephone by stating a URL, URI, URN and registered internet domain names. It can also be a pre-selected sequential word sequence that are not associated with a geographical location (city, state, ex) and that are not URL, URI, URN and registered Internet domain names.

The ability to have an entity use a telephone (non-web enabled device) that would allow him to perform a search similar to an internet search engine (web enabled device) without any human interaction (including behind the scenes). That would result in the querying entity being directly connected on a phone with the entity that fits that specific search result.

Web enabled search engines all compile data in a similar matter. They go into cyberspace, follow links, any copy everything they come across and later index copied information (via web crawlers and spiders). When an asker, one who asks or queries a web search, approaches the search engine and enters in his search parameters, the search engine returns results. The asker then has to review the results to pinpoint the specific results he needs. Often, this is a time consuming process.

By way of example, presently, if one calls a concierge service on the telephone the operator is doing this process for the asker by manually narrowing the results that of a search engine in order to pinpoint the desired information.

NLID of the present invention compiles its data differently than typical search engines. Most search engines go out and gather information from cyberspace and then later index it. NLID does not go out to gather information. Entities come to the NLID and give the NLID their specific information. This is the key factor that allows the NLID to facilitate a direct connection over the phone between the querying entity and the qualifying entity directly without human interaction.(i.e. concierge service).

Example Demonstrating Web Search with NLI Search of the Present Invention:
Web Enabled Device

Asker goes to google search engine and enters into a search box “DOCTOR, NORTH MIAMI BEACH, PEDIATRICIAN, THAT ACCEPTS HMO INSURANCE, OPEN ON SATURDAYS” The search engine will return a fistful of information that you will have to manually sift through.

COMPARE With:

Call made over the phone using the NLID System of the present invention:

Asker calls NLID access number and says the same search parameters. The entity will then be forwarded directly to the qualified entity. This was done through an internal search of the key statistics of the NLI. The results of the query are singular and there is no sifting through information to pinpoint the qualified entity.

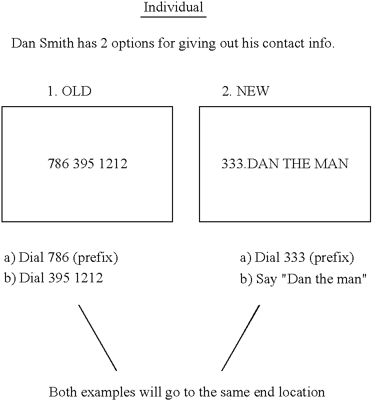

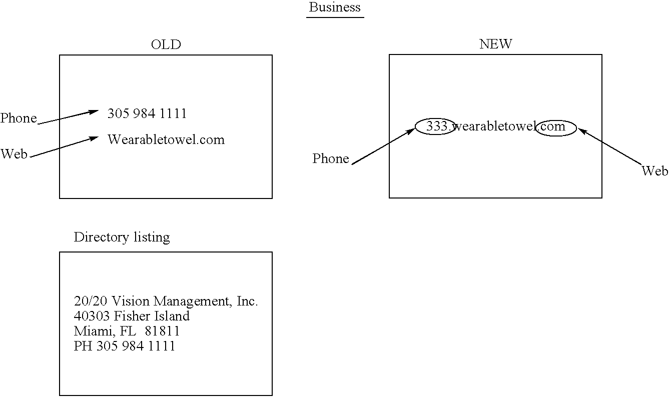

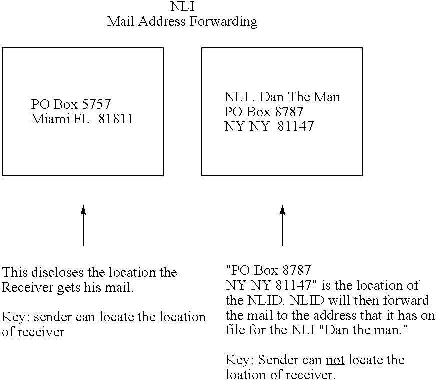

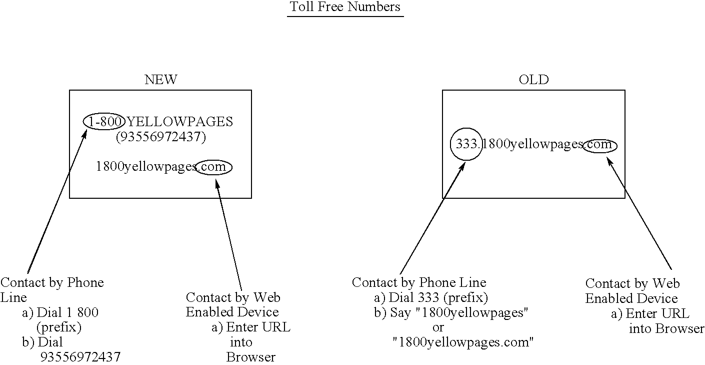

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for providing a connection to a particular entity from a request made to the system, the system providing:
(a) a central access telephone number;
(b) a database of word sequences purchased by entities;
wherein the database directly facilitates a connection between an existing URL, URI, URN or registered internet domain names purchased as word sequences by said entities with entity presenting a query.

2. The system of claim 1 wherein the system connects a entity making a query of the system directly to a desired registered entity without the need for a querrier to provide a contact telephone number.

3. The system of claim 1 wherein the associated contact telephone number may be changed at any time by the entity that has purchased said word sequence.

4. The system of claim 1 wherein the associated contact telephone number is not revealed to persons accessing said system and requesting connection to an entity associated with a particular word sequence.

5. A system that directly facilitates a connection between a pre-selected sequential word sequence that are not associated with a geographical location and that are not existing URL, URI, URN and registered internet domain names with a telephone number, or a physical address, with an entity making a query of said system.

6. A system to inform an entity of the ability to contact another entity on a telephone by stating a URL, URI, URN and registered internet domain names, said system providing notification by a pre-selected sequential word sequence that are not associated with a geographical location and that are not URL, URI, URN and registered Internet domain names.

7. A system that provides for an entity access using use a conventional telephone that is not Internet or web enabled, that would allow the entity to perform a search similar to an internet search engine (web enabled device) without any human interaction, that would result in the querying entity being directly connected on a phone with the entity that fits that specific search result.
